(19) United States
(12) Patent Application Publication
(10) Pub. No.: US 2021/0293377 A1
(43) Pub. Date: Sep. 23, 2021

(54) ELECTRONIC DEVICES WITH STANDING MECHANISMS FOR IMPROVED USER EXPERIENCE

(71) Applicant: Refliko, Inc., San Francisco, CA (US)

(72) Inventor: Kendall Chow, San Francisco, CA (US)

(21) Appl. No.: 17/207,093

(22) Filed: Mar. 19, 2021

Related U.S. Application Data
(60) Provisional application No. 62/992,757, filed on Mar. 20, 2020.

(51) Int. Cl. F16M 13/00; G06F 3/044; G09G 5/10; G06F 3/0488; G06F 1/3296; G06F 1/3231; A47G 1/02; A47G 1/16

(52) U.S. Cl. CPC F16M 13/005; G06F 3/044; G09G 5/10; G06F 3/04886; G06F 1/3296; G09G 2354/00; A47G 1/02; A47G 1/16; G06F 2203/04104; G09G 2330/023; G06F 1/3231

(57) ABSTRACT

Standing mechanisms including supports are described for providing a fixed or configurable lean or tilt to large form factor electronic devices. In one embodiment, a support for a large form factor electronic device comprises a base support to provide a fixed or configurable angle to provide a lean to the large form factor electronic device. An upper support supports a backside of a display panel of the large form factor electronic device.

### CROSS-REFERENCE

This patent application is related to and, under 35 U.S.C. 119, claims benefit of and priority to U.S. Provisional Patent Application No. 62/992,757, entitled ELECTRONIC DEVICES WITH STANDING MECHANISMS FOR IMPROVED USER EXPERIENCE, by Kendall Chow, filed Mar. 20, 2020, Attorney Docket No. REFLIKO-P002Z, where the contents of which are incorporated herein by reference.

### FIELD OF THE INVENTION

Embodiments of the invention are generally related to smart electronic devices with a standing mechanism and multitouch control to interact, consume and create content.

### BACKGROUND

Current smart mirror devices are mounted to a vertical surface. Users may have difficulty with touch interactions for vertically mounted smart mirror devices.

### SUMMARY

Standing mechanisms including supports are described for providing a fixed or configurable lean or tilt to large form factor electronic devices. In one embodiment, a support for a large form factor electronic device comprises a base support to provide a fixed or configurable angle to provide a lean to the large form factor electronic device. An upper support supports a backside of a display panel of the large form factor electronic device.

Other embodiments are also described. Other features of embodiments of the present invention will be apparent from the accompanying drawings and from the detailed description which follows.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 shows an embodiment of a frontal view of a large form factor electronic device 100 (e.g., smart mirror device 100) having capacitive touch control in accordance with one embodiment.

FIG. 2 shows an embodiment of a side view of a large form factor electronic device 200 (e.g., smart mirror device) that is supported with a slight lean with support 210 in accordance with one embodiment.

FIG. 3A shows an embodiment of a first side view of a large form factor electronic device 300 (e.g., smart mirror device) that is supported with a slight lean with support 310 in accordance with one embodiment.

FIG. 3B shows an embodiment of a second side view of a large form factor electronic device 300 (e.g., smart mirror device) that is supported with a slight lean with support 310 in accordance with one embodiment.

FIG. 4 shows an embodiment of a rear view of a large form factor electronic device 400 (e.g., smart mirror device) that is supported with a slight lean with support 410 in accordance with one embodiment.

FIG. 5 shows an embodiment of a side view of a large form factor electronic device 500 (e.g., smart mirror device) that is supported with a slight lean with support 510 in accordance with one embodiment.

FIG. 6A shows an embodiment of a first side view of a large form factor electronic device 600 (e.g., smart mirror device) that is supported with a slight lean with support 610 in accordance with one embodiment.

FIG. 6B shows an embodiment of a second side view of a large form factor electronic device 600 (e.g., smart mirror device) that is supported with a slight lean with support 610 in accordance with one embodiment.

FIG. 7 shows an embodiment of a rear view of a large form factor electronic device (e.g., smart mirror device) that is supported with a slight lean with support 710 in accordance with one embodiment.

FIG. 8 illustrates a state diagram 800 for different states of a large form factor electronic device in accordance with certain embodiments.

FIG. 9 shows an embodiment of a block diagram of a system 900 for providing augmented reality with large form factor devices via a network 905 in accordance with one embodiment.

FIG. 10 is a block diagram of a wireless large form factor device 1700 in accordance with one embodiment.

### DETAILED DESCRIPTION

Electronic devices with standing mechanisms to optimize user interaction with a touch region having multitouch capacitive control are described. These electronic devices with a large form factor provide augmented reality for a user to experience software applications (apps) and services with a large human sized screen (e.g., portrait oriented screen for smart mirror device) that is significantly larger than existing mobile and tablet devices. In comparison to mobile and tablet devices, large form factor electronic devices do not need to be held by a user, have improved audio, better microphones due to no size constraint, use as a mirror, and are also considered a furniture centerpiece of a home.

User trials and experiments indicate that in the natural motion of using a smart mobile device, the mobile device is not 90 degrees to a user's face. In fact, there is a slight angle for which a user holds the mobile device, specifically when providing input into the device.

In another example, when writing with a pen/pencil on paper on a table, a user has a slight angle/lean from the face to the piece of paper when writing.

In another example, for the same reason as discussed above, a white board that is mounted on a vertical wall is uncomfortable to use, because the wall is exactly 90 degrees to the user's face and body, so users naturally tend to write from the side or slightly squat to achieve a “lean” or “angle” from the face/body to the white board, to make writing more comfortable and optimal.

The large form factor electronic devices of the present application are designed with a support or a stand (e.g., standing mechanism to support the electronic device) to intentionally provide a slight lean (e.g., 3-15 degrees, 7 degrees) to improve user interaction with the touch display region and eliminate uncomfortable or poor posture positions for interacting with the touch display region.

These large form factor electronic devices are bezel-less with a capacitive oleophobic touch interface in contrast to typically IR touch mirror devices. These devices are bezel-less with no frame, or the frame is very narrow where it is near invisible. This is a completely unique design for mirrors, only achievable through our design because there are numerous layers of lamination, the cap touch, the display, and the enclosure. Thus, the entire stackup is holding the device together and flat and a frame is not necessary. These large form factor electronic devices also have a 3D depth sensing device for enhanced user interaction that allows new experiences in different types of applications (e.g., fitness workouts, video conferencing, telemedicine, Gaming, Education, Point of Sale, Online retail shopping, Clothes/Fashion sales, Cosmetics, Computer Vision applications, Voice assistant technology, Natural Language Processing, Security, Content consumption, Set top box hub, Home hub (e.g., smart home controller), Agnostic to platform in terms of operating with different types of home platforms, and Maps.

In comparison to conventional smart mirrors, the large form factor electronic devices have full CPU/electronics, Camera, Speaker out, Microphone in, Capacitive touch, LCD display or OLED, App store capability, Android APK loadable, a large form factor software application download capability, ability to display time/weather etc., motion sense, infinite number of apps and services, and landscape orientation for Coffee table device.

These large form factor electronic devices can be utilized as furniture within an indoor environment or a protected outdoor environment. The large form factor electronic devices each have a reflective mode to provide a reflective mirror surface for users or alternatively no reflective mode is included to optimize display characteristics for a user. A large form factor electronic device in combination with a support or a stand forms an apparatus. Alternatively, a large form factor electronic device can be mounted to a substantially vertical surface (e.g., wall) without a support or stand.

In this section several embodiments of this invention are explained with reference to the appended drawings. Whenever the shapes, relative positions and other aspects of the parts described in the embodiments are not clearly defined, the scope of the invention is not limited only to the parts shown, which are meant merely for the purpose of illustration.

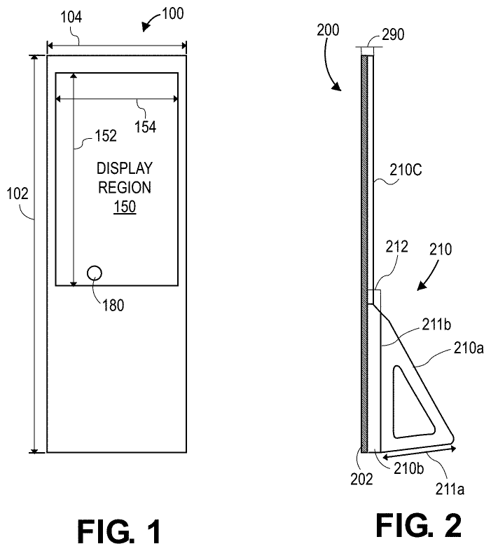

FIG. 1 shows an embodiment of a frontal view of a large form factor electronic device 100 having capacitive touch control in accordance with one embodiment. The device 100 includes a support (e.g., 210, 310, 410) as illustrated in FIGS. 2-4 to provide a standing mechanism with a slight lean. The device 100 (e.g., 43″, 49″, 55″, 2 k, 4 k, 8 k, OLED, etc.) and a display region 150 having a plurality of display modes including an active device mode for using apps, a low power sleep mode, and an optional reflective mirror mode to provide reflectivity of a mirror.

In one example, the device 100 has the following dimensions. The large form factor device 100 has a height 102 (e.g., 1600-2000 mm, 60-80 inches), a width 104 (e.g., 500-700 mm, 20-30 inches), a support 210, 310, or 410 has a width 412 (e.g., 500-700 mm, 20-30 inches), a display region width 154 (e.g., 500-700 mm, 20-30 inches), and a display region height 152 (e.g., 800-1200 mm, 30-50 inches).

FIG. 2 shows an embodiment of a side view of a large form factor electronic device 200 (e.g., smart mirror device) that is supported with a slight lean with support 210 in accordance with one embodiment. A capacitive touch control can be laminated onto the display panel 202 of the device 200. In one example, the device 200 has the following dimensions.

The device 200 includes a fixed or configurable angle support 210. In one example, this support 210 includes a base support 210a, an intermediate support 210b, and an upper support 210c. The base support has a depth 211a (e.g., 400-700 mm, 15-30 inches) and a height 211b (e.g., 400-700 mm, 15-30 inches). Intermediate support 210b has a thickness 212 (e.g., 70-100 mm, 2.75-4 inches). The upper support 210c and display panel have a combined thickness 290 (e.g., 40-50 mm, 1.5-2 inches).

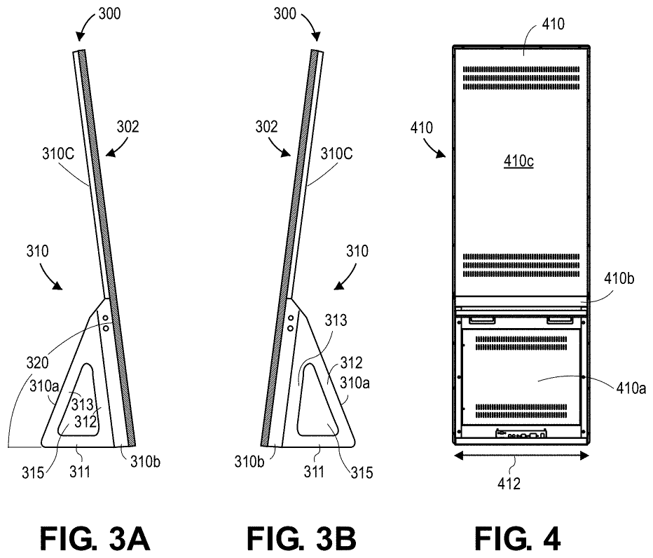

FIG. 3A shows an embodiment of a first side view of a large form factor electronic device 300 (e.g., smart mirror device) that is supported with a slight lean with support 310 in accordance with one embodiment. A capacitive touch control can be laminated onto the display panel 302 of the device 300.

The support 310 can have a fixed or configurable angle 320 (e.g., 75-90 degrees, approximately 82-84 degrees) to provide a lean to this device 300. The angle 320 extends from a primarily horizontal ground level to a backside of the device 300 that has a portrait orientation. In one example, this support 310 includes a base support 310a, an intermediate support 310b, and an upper support 310c. The base support 310a may include supports 311, 312, and 313 and an optional opening 315. Alternatively, the base support 310a may include additional or fewer supports.

FIG. 3B shows an embodiment of a second side view of a large form factor electronic device 300 (e.g., smart mirror device) that is supported with a slight lean with support 310 in accordance with one embodiment. A capacitive touch control can be laminated onto the display panel 302 of the device 300.

The support 310 can have a fixed or configurable angle to provide a lean to this device 300. In one example, this support 310 includes a base support 310a, an intermediate support 310b, and an upper support 310c. The base support 310a may include supports 311, 312, and 313 and an optional opening 315. Alternatively, the base support 310a may include additional or fewer supports.

FIG. 4 shows an embodiment of a rear view of a large form factor electronic device 400 (e.g., smart mirror device) that is supported with a slight lean with support 410 in accordance with one embodiment. A capacitive touch control can be laminated onto the display panel of the electronic device.

In one example, this support 410 includes a base support 410a, an intermediate support 410b, and an upper support 410c.

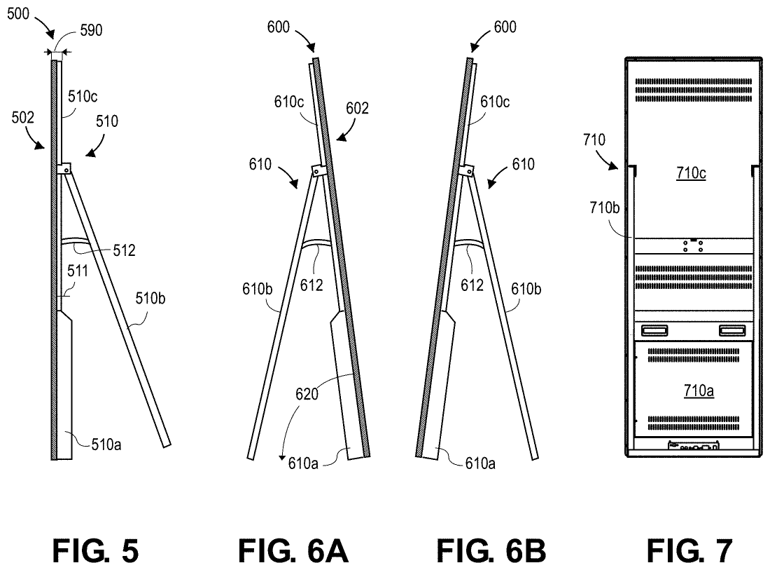

FIG. 5 shows an embodiment of a side view of a large form factor electronic device 500 that is supported with a slight lean with support 510 in accordance with one embodiment. A capacitive touch control can be laminated onto the display panel 502 of the device 500.

The device 500 is supported with a configurable angle support 510. In one example, this support 510 includes a base support 510a, an intermediate support 510b, and an upper support 510c. The base support has a depth 511 (e.g., 70-100 mm, 2.75-4 inches). Intermediate support 510b can be a kick stand structure with a mechanism 512 to adjust positioning of the intermediate support 510b. The upper support 510c and display panel have a combined thickness 590 (e.g., 40-50 mm, 1.5-2 inches).

FIG. 6A shows an embodiment of a first side view of a large form factor electronic device 600 (e.g., smart mirror device) that is supported with a slight lean with support 610 in accordance with one embodiment. A capacitive touch control can be laminated onto the display panel 602 of the device 600.

The support 610 can have a configurable angle 620 (e.g., 75-90 degrees, 81 degrees, 83 degrees, 85 degrees, 87 degrees, etc.) to provide a lean to this device 600. The angle 620 extends from a primarily horizontal ground level to a backside of the device 600 that has a portrait orientation. In one example, this support 610 includes a base support 610a, an intermediate support 610b, and an upper support 610c. Intermediate support 610b can be a kick stand structure with a mechanism 612 to adjust positioning of the intermediate support 610b from a non-extended position that is parallel with a longitudinal axis of the device 600 to an extended position that is illustrated in FIG. 6A. The mechanism 612 may also provide stable intermediate positions to adjust tilt or lean between the non-extended position and the extended position.

FIG. 6B shows an embodiment of a second side view of a large form factor electronic device 600 (e.g., smart mirror device) that is supported with a slight lean with support 610 in accordance with one embodiment. A capacitive touch control can be laminated onto the display panel 602 of the device 600.

The support 610 can have a configurable angle to provide a lean to this device 600. In one example, this support 610 includes a base support 610a, an intermediate support 610b, and an upper support 610c.

Intermediate support 610b can be a kick stand structure with a mechanism 612 to adjust positioning of the intermediate support 610b from a non-extended position that is parallel with a longitudinal axis of the device 600 to an extended position that is illustrated in FIG. 6B. The mechanism 612 may also provide stable intermediate positions to adjust tilt or lean between the non-extended position and the extended position.

FIG. 7 shows an embodiment of a rear view of a large form factor electronic device (e.g., smart mirror device) that is supported with a slight lean with support 710 in accordance with one embodiment. A capacitive touch control can be laminated onto the display panel of the electronic device.

In one example, this support 710 includes a base support 710a, an intermediate support 710b, and an upper support 710c. The large form factor electronic devices described herein can include a mirror mode to provide a reflective surface to a user or alternatively these large form factor electronic devices may not include the mirror mode.

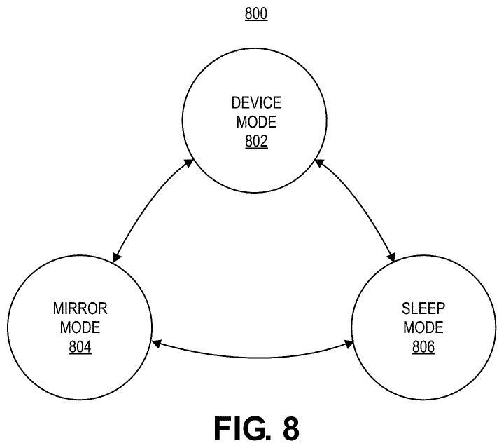

FIG. 8 illustrates a state diagram 800 for different states of a large form factor electronic device in accordance with certain embodiments. The operational flow or transitions between states is performed by a smart electronic device, which includes processing circuitry or processing logic. The processing logic may include hardware (circuitry, dedicated logic, etc.), software (such as is run on a general purpose computer system or a dedicated machine or a device), or a combination of both.

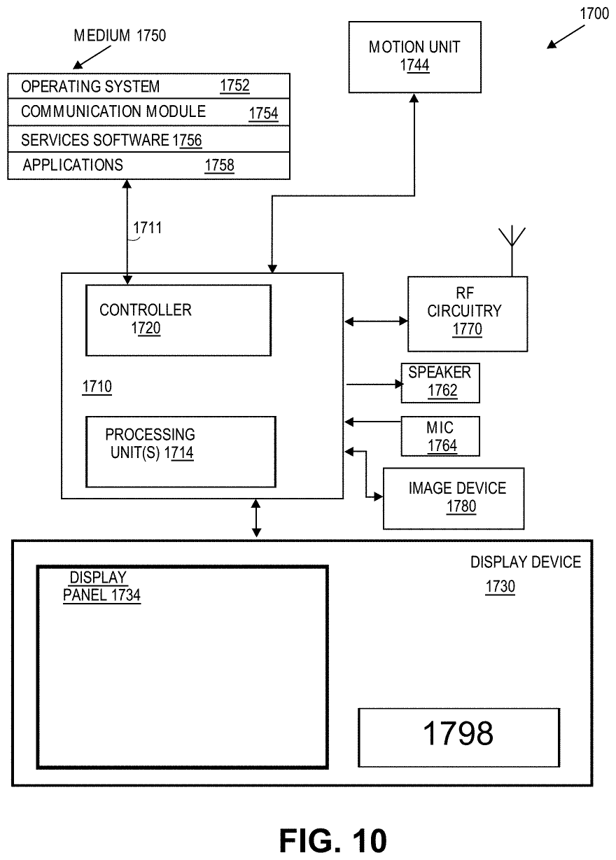

At device mode 802, a large form factor electronic device has full device functionality including full use of CPU/electronics, Camera, Speaker out, Microphone in, Capacitive touch, LCD display or OLED, App store capability for large form factor applications, Android APK loadable, a large form factor software application download capability, ability to display time/weather etc., motion sense, infinite number of apps and services. Upon receiving a sleep mode user input (e.g., virtual button 180 of FIG. 1) while in device mode, the device switches to a sleep mode 806. In one example of the sleep mode, the device enters a lower power mode for some of the electronics (e.g., frequency or power scaling of CPU) and displays a preselected or predetermined display background on the display region of the device. In another example of the sleep mode, the device enters a lower power mode for some of the electronics (e.g., frequency or power scaling of CPU) and also shuts down display backlight circuitry 1798 of FIG. 10 causing no light to be emitted from the backlight circuitry through the display region/panel 1734 (e.g., LCD display or OLED 1734) and switching the device to a mirror mode 804. A user can choose in settings of the smart mirror device which sleep mode to enter. Either (a) screen saver which is a background image (static or moving) or (b) the backlight turns completely off, but the device is still powered on. In mirror mode 804, ambient light is reflected from the display panel to provide mirror reflection and functionality for a user to be able to view a reflection of the user.

The device switches from mirror mode 804 to device mode 802 based on receiving a touch input anywhere on a display region of the device. In a similar manner, the device switches from sleep mode 806 to device mode 802 based on receiving a touch input anywhere on a display region of the device. Thus, the capacitive touch functionality continues to operate in sleep mode and mirror mode.

The device can also switch from mirror mode 804 to device mode 802 if at least one user gazes or looks at the device for a threshold time period.

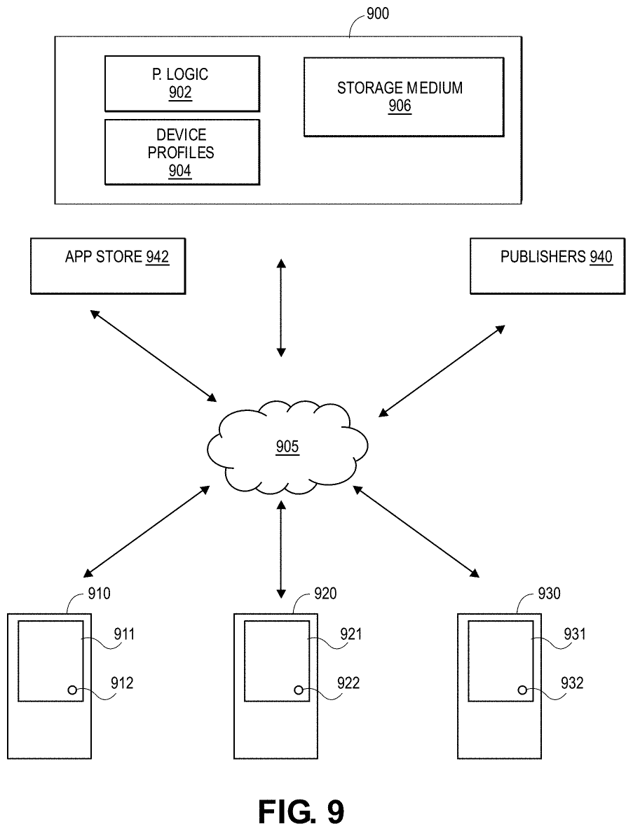

FIG. 9 shows an embodiment of a block diagram of a system 900 for providing augmented reality with large form factor devices via a network 905 in accordance with one embodiment. The system 900 includes processing logic 902 to execute instructions for software applications or programs, large form factor device profiles 904, and storage medium 906. The system 900 provides services to devices 910, 920, and 930 (e.g., large form factor devices, etc.) via a network 905. A device profile for a device is based on one or more parameters including location of the device, categories or types of applications installed on the device, and user purchases.

The publishers 940 publish content for use in applications. The application store 942 for any type of operating system of a device provides large form factor apps to be downloaded onto a large form factor device. The large form factor apps are optimized for use and user interaction on a large form factor device. The system 900, devices 910, 920, 930, publishers 940, and application store 942 communicate via the network 905 (e.g., Internet, wide area network, WiMax, satellite, cellular (e.g., 4G, 5G), IP network, etc.).

In one embodiment, each device 910, 920, and 930 includes a display region 911, 921, and 931 respectively. The devices are each executing a collaboration application for sharing documents, video, audio, etc to collaborate. A virtual button (e.g., 912, 922, 932) allows a user to capture a screen shot of the display region to easily capture content from the collaboration.

In one example, the virtual button is a screen capture icon that is a default setting for the device. This screen capture icon is important specifically in the use case of remote white board collaboration. Having this icon as a default setting, greatly enhances the user experience while collaborating. Typically, most users upon completion of white boarding snap a picture with their phones and send via email or chat groups. This screen capture mechanism allows users to capture screen shot images on their large form factor devices and then email directly from the large form factor devices.

FIG. 10 is a block diagram of a wireless large form factor device 1700 (e.g., smart mirror device, smart tabletop device) in accordance with one embodiment. The wireless device 1700 includes a processing system 1710 (e.g., SoC) that includes a controller 1720 and processing units 1714. The processing system 1710 communicates with a display device 1730, radio frequency (RF) circuitry 1770, speaker 1762, mic 1764, an image capturing device 1760 for capturing one or more images or video, a motion device 1744 (e.g., an accelerometer, gyroscope) for determining motion data (e.g., in three dimensions, 6 axis, etc.) for the wireless device 1700, and machine-accessible non-transitory medium 1750. These components are coupled by one or more communication links or signal lines.

RF circuitry 1770 is used to send and receive information over a wireless link or network to one or more other devices. RF circuitry 1770 can include BlueTooth and WiFi modules (e.g., A2DP/HFP).

The processing system communicates with one or more machine-accessible non-transitory mediums 1750 (e.g., computer-readable medium). Medium 1750 can be any device or medium (e.g., storage device, storage medium) that can store software code and data for use by one or more processing units 1714. Medium 1750 can include cache, main memory and secondary memory. The medium 1750 stores one or more sets of instructions embodying any one or more of the methodologies or functions described herein. The software may include an operating system 1752, services software 1756 for operations of the large form factor devices discussed herein, communications module 1754, and applications 1758 (e.g., publisher applications, developer applications, a web browser, htm15 applications, etc.). The software may also reside, completely or at least partially, within the medium 1750 or within the processing units 1714 during execution thereof by the device 1700. The components shown in FIG. 10 may be implemented in hardware, software, firmware or any combination thereof, including one or more signal processing and/or application specific integrated circuits.

Communication module 1754 enables communication with other devices. The processing system communicates with display device 1730 (e.g., a display, a liquid crystal display (LCD), OLED, a plasma display, capacitive touch display device 1734 with multipoint touch (e.g., 2 point touch, 5 point touch, 10 point touch), or touch screen for receiving user input and displaying output, an optional alphanumeric input device) having a display panel 1734.

In one example, the mirror and tabletop devices have Android based software and will allow a user to load apps by accessing an app store (e.g., Play store). An image capturing device 1780 may include a standard camera, a 3D Depth camera that allows a user to interact with the device 1700 based on gesturing from a certain distance away (e.g., 1-20 ft) from the device 1700. The device 1700 is designed with an App store that is specific to the hardware of the device. The device 1700 has over the air (OTA) capability to update software. The image capturing device or other sensors can sense user motion and intent to detect whether to turn on/off a backlight of the display device to transition from pure mirror mode (e.g., reflection mode) to electronic mode. The display device may include an Oleophobic/Hydrophobic coating for less fingerprint, and smoother swipes. In one example, the device 1700 includes a power plug but does not include a battery source.

In one embodiment, a machine-accessible non-transitory medium contains executable computer program instructions which when executed by a data processing system cause the system to perform any of the methods discussed herein. While the machine-accessible non-transitory medium 1750 is shown in an exemplary embodiment to be a single medium, the term “machine-accessible non-transitory medium” should be taken to include a single medium or multiple media (e.g., a centralized or distributed database, and/or associated caches and servers) that store the one or more sets of instructions. The term “machine-accessible non-transitory medium” shall also be taken to include any medium that is capable of storing, encoding or carrying a set of instructions for execution by the machine and that cause the machine to perform any one or more of the methodologies of the present invention. The term “machine-accessible non-transitory medium” shall accordingly be taken to include, but not be limited to, solid-state memories, optical and magnetic media, and carrier wave signals.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A support for a large form factor electronic device, comprising:
a base support to provide a fixed or configurable angle to provide a lean to the large form factor electronic device to improve user interaction with a touch display region of the large form factor electronic device having multitouch capacitive control; and
an upper support to support a backside of a display panel of the large form factor electronic device.

2. The support of claim 1, wherein the fixed or configurable angle of 75 to 87 degrees extends from a primarily horizontal ground level to a backside of the large form factor electronic device that has a portrait orientation.

3. The support of claim 1, wherein the fixed or configurable angle is approximately 82 degrees to 84 degrees.

4. The support of claim 1, further comprising:
an intermediate support coupled to the base support with the intermediate support providing a lean to the large form factor electronic device that has a reflective mirror mode and an active device mode for user interactions with the touch display region.

5. The support of claim 4, wherein the base support has a depth of 15 to 21 inches and the intermediate support has a thickness of 2.75 to 4 inches.

6. An apparatus, comprising:
a large form factor electronic device with a touch region having multitouch capacitive control;
an intermediate support to provide a fixed or configurable angle to provide a lean to the large form factor electronic device; and
a base support to support a backside of a display panel of the large form factor electronic device.

7. The apparatus of claim 6, wherein the fixed or configurable angle of 75 to 87 degrees extends from a primarily horizontal ground level to the backside of the large form factor electronic device that has a portrait orientation.

8. The apparatus of claim 6, wherein the fixed or configurable angle is approximately 82 degrees to 84 degrees.

9. The apparatus of claim 6, further comprising:
an upper support coupled to the intermediate support with the upper support to support the backside of the large form factor electronic device.

10. The apparatus of claim 6, wherein the base support has a depth of 2.75 to 4 inches.

11. The apparatus of claim 6, wherein the intermediate support comprises a kick stand structure with a mechanism to adjust positioning of the intermediate support from a non-extended position that is parallel with a longitudinal axis of the large form factor electronic device to an extended position.

12. The apparatus of claim 11, wherein the mechanism provides stable intermediate positions to adjust tilt or lean between the non-extended position and the extended position.

13. The apparatus of claim 6, wherein the base support has a depth of 15 to 21 inches and the intermediate support has a thickness of 2.75 to 4 inches, wherein the large form factor electronic device comprises a mirror mode to provide a reflective surface and a device mode to allow user interaction with the touch region.

14. The apparatus of claim 6, wherein the large form factor electronic device has a height of 60 to 80 inches and a width of 20 to 30 inches.

15. A smart mirror device, comprising:
a storage medium to store software programs and software applications;
a capacitive touch control;
a display device having a plurality of display modes including a device mode to provide device functionality including a large form factor software application download capability, a sleep mode, and a mirror mode; and
processing logic coupled to the storage medium and the display device, the processing logic is configured to execute instructions of at least one of the software programs or software applications in response to receiving user input from the capacitive touch control of the smart mirror device having a large form factor.

16. The smart mirror device of claim 15, wherein the mirror mode comprises a reflective mirror mode and the device mode comprises an active device mode to provide device functionality including full use of electronics including a CPU, a camera, a speaker output, a microphone, the capacitive touch control, the display device, a large form factor software application download capability, motion sense, and ability to operate applications and services.

17. The smart mirror device of claim 15, wherein the processing logic is further configured to switch from the device mode to the sleep mode based on receiving a user input from the capacitive touch control.

18. The smart mirror device of claim 17, wherein upon entering the sleep mode, the smart mirror device enters a first low power mode for some electronics including a CPU and displays a preselected or predetermined display background on a display region of the display device.

19. The smart mirror device of claim 17, wherein upon entering the sleep mode, the smart mirror device enters a second low power mode for some electronics including a CPU and shuts down display backlight circuitry to cause no light to be emitted from the backlight circuitry to a display region of the display device.

20. The smart mirror device of claim 17, wherein the processing logic is further configured to switch from the mirror mode to the device mode based on receiving a touch input anywhere on a display region of the display device.

21. The smart mirror device of claim 16, wherein the processing logic is configured to execute instructions of a collaboration application for sharing content between users and to provide a virtual button to the display device to allow a user to capture a screen shot of a display region to easily capture content from collaboration.
